(19) United States
(12) Patent Application Publication
(10) Pub. No.: US 2026/0011849 A1
(43) Pub. Date: Jan. 8, 2026

(54) DETACHMENT STRUCTURE OF A POWER-ASSISTING BATTERY

(71) Applicant: New Century Products Co., Ltd., Taipei City (TW)

(72) Inventor: Fu-Tsun LIN, Taipei City (TW)

(21) Appl. No.: 18/810,546

(22) Filed: Aug. 21, 2024

(30) Foreign Application Priority Data
Jul. 4, 2024 (CN) 202421564873.0

(51) Int. Cl. H01M 50/264; B62B 5/00; H01M 50/24; H01M 50/249; H01M 50/256

(52) U.S. Cl. CPC H01M 50/264; B62B 5/0043; B62B 5/0053; B62B 5/0066; H01M 50/24; H01M 50/249; H01M 50/256

(57) ABSTRACT

A detachment structure of a power-assisting battery, applicable to a cart, includes a support module, two motor wheel sets, and a battery module. The support module includes two structurally identical supports. One end of each support has a raised element and a dented element. The supports are fitted together because the raised elements engage with the dented elements. Each motor wheel set has an axle and a quick-release transmission connector. The battery module includes a battery holder, driver unit, and replaceable battery. The battery holder has a receiving chamber, waterproof cover, and fixing component. The driver unit includes a driver and a signal port. The battery is disposed in the receiving chamber and has a grip whereby the battery can be pulled by a user. The driver and the battery holder are integrated into the battery module. The fixing component allows the waterproof cover to be locked and unlocked.

### TECHNICAL FIELD

The present disclosure relates to a detachment structure of a power-assisting battery, and more particularly to a detachment structure of a power-assisting battery, comprising two structurally identical supports sharing a mold for production purposes, a driver and a waterproof, dustproof battery holder together integrated into a battery module, a replaceable battery easy to pull outward by a user, and a waterproof cover easy to be shut and locked as well as unlocked and opened, allowing the battery holder to charge multiple batteries simultaneously.

### BACKGROUND

Taiwan's patent M636844, entitled Cart with Detachable Power-assisting Structure, discloses a cart, a power control module, and a battery unit. The cart comprises a front wheel component, a rear wheel component, a left folding component and a right folding component. The front ends of right and left folding braces are pivotally connected to the front wheel component. The rear ends of right and left folding braces are pivotally connected to the rear wheel component. The power control module is disposed at the bottom of the rear wheel component and comprises a driving motor capable of outputting a rotational speed and outputting a torque, a gearbox and a power outputting shaft. One end of the power outputting shaft connects to the gearbox. The other end of the power outputting shaft connects to a rear right wheel or a rear left wheel. The gearbox drives the power outputting shaft to rotate, allowing the rear right wheel or the rear left wheel to work. The battery unit connects to the driving motor to serve as a power source.

Taiwan's patent M636844 discloses the adjustment of a deceleration mechanism and the driving motor to achieve personalized control and optimal safe use and discloses a quick-release replaceable power structure applicable to multipurpose vehicles and pet strollers, allowing the cart of Taiwan's patent M636844 to have wide applications.

In practice, during its operation, the power-assisting structure of Taiwan's patent M636844 requires two batteries detachably mounted in front of and behind a driving controller respectively, resulting in the drawbacks as follows:
1. The rear one of the two batteries detachably mounted in front of and behind the driving controller respectively is blocked by the cart and thus is difficult to be detached.
2. Although the batteries can be separately charged, they must be taken out in order to be charged. The required charger takes up all the space of the device system.
3. The battery holder that contains the batteries is exposed, and its concealing lid is not waterproof or dustproof.

As a result, there is still room for improvement in the prior art.

### SUMMARY

In view of the aforesaid drawbacks of the prior art, it is an objective of the disclosure to provide a detachment structure of a power-assisting battery, comprising two structurally identical supports sharing a mold for production purposes, a driver and a waterproof, dustproof battery holder together integrated into a battery module, a replaceable battery easy to pull outward by a user, and a waterproof cover easy to be shut and locked as well as unlocked and opened, allowing the battery holder to charge multiple batteries simultaneously.

To achieve the above and other objectives, the disclosure provides a detachment structure of a power-assisting battery, applicable to a cart, comprising: a support module comprising two supports each having an end, the end having a raised element and a dented element, the supports being fitted together because of the raised elements engaging with the dented elements respectively, the supports jointly defining a receiving space, with a removable side lid disposed on a side of each of the supports and a transmission line received in each of the supports, the transmission line having an end protruding from the support, wherein another end of each of the supports is joined to a wheel carrier disposed at the cart; two motor wheel sets, each having therein a driving motor and each having an axle, the axle being removably penetratingly disposed at the wheel carrier and a corresponding one of the supports, the driving motor extending to form a quick-release transmission connector, wherein, after passing through the axle, the quick-release transmission connector is removably joined to another end of the transmission line; and a battery module disposed in the receiving space and comprising a battery holder, a driver unit, and at least one battery, the battery holder being connected to an end of the transmission line, having at least one receiving chamber, being movably, pivotally connected to a waterproof cover to conceal the receiving chamber, and having at least one fixing component for engaging with the waterproof cover, the driver unit comprising a driver and a signal port electrically connected to each other, the driver connecting to the battery holder, and the signal port receiving control signals, with the battery removably disposed in the receiving chamber and having a grip disposed anteriorly.

According to the disclosure, the supports are structurally identical and share a mold required for their production to reduce mold making cost and production cost.

According to the disclosure, the driver and the battery holder are integrated into the battery module, and the battery is replaceable.

According to the disclosure, owing to the waterproof cover, the battery holder is waterproof and dustproof.

According to the disclosure, a user can pull the battery outward easily by the grip of the battery, and the fixing component allows the waterproof cover to be shut and locked as well as unlocked and opened.

According to the disclosure, the battery holder can charge multiple batteries simultaneously.

### BRIEF DESCRIPTION OF THE DRAWINGS

FIG. 1 is a perspective view of the disclosure.

FIG. 2 is a perspective view of the disclosure, showing a support module of the disclosure.

FIG. 3 is a perspective view of the disclosure, showing the support module of the disclosure from another angle.

FIG. 4 is a schematic view of the disclosure, showing how to use a side lid of the disclosure.

FIG. 5 is a schematic view of the disclosure, showing how to use a motor wheel set of the disclosure.

FIG. 6 is an exploded view of a battery module of the disclosure.

FIG. 7 through FIG. 9 are schematic views of the disclosure, showing how to remove a battery.

### DETAILED DESCRIPTION

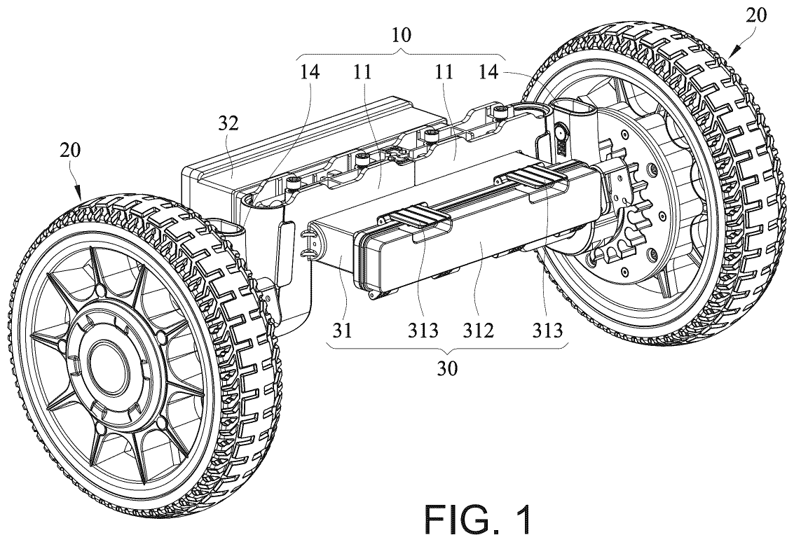

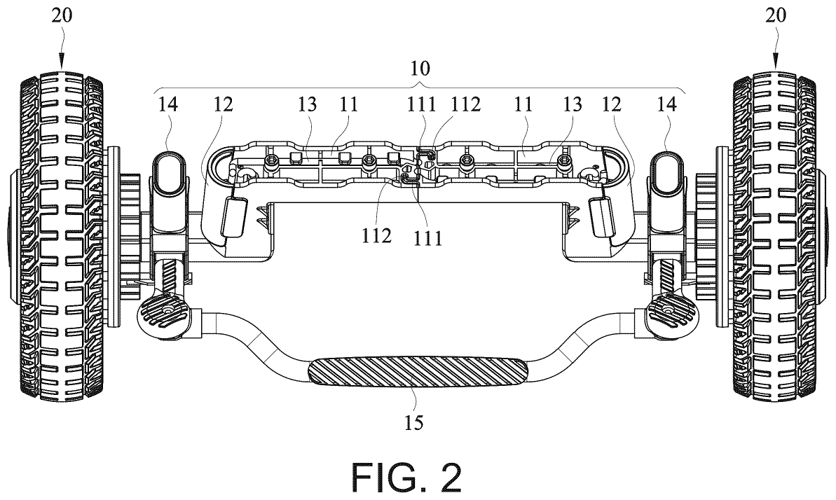

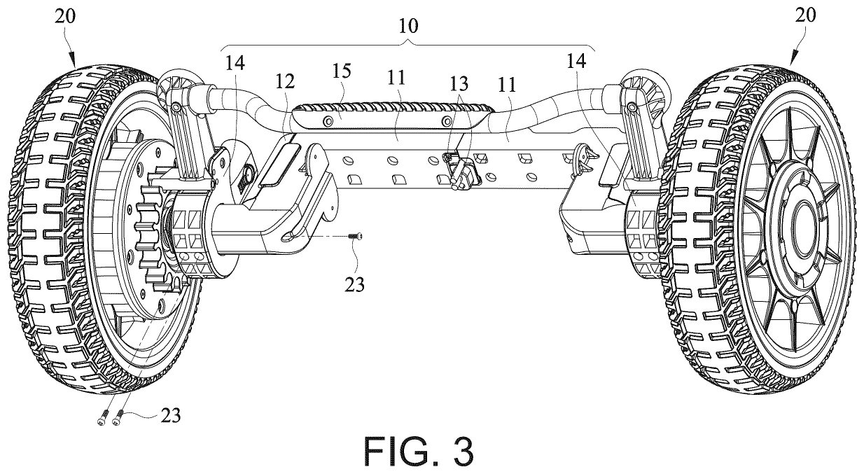

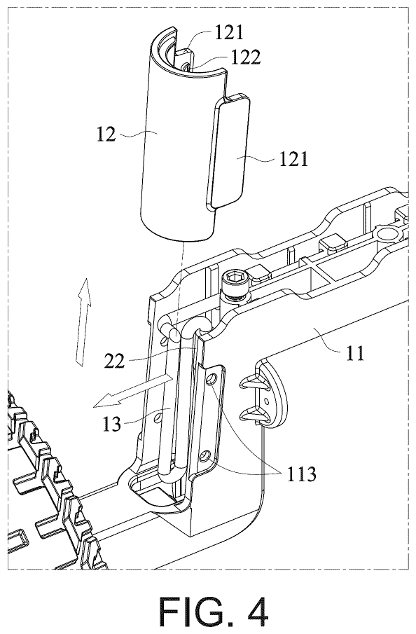

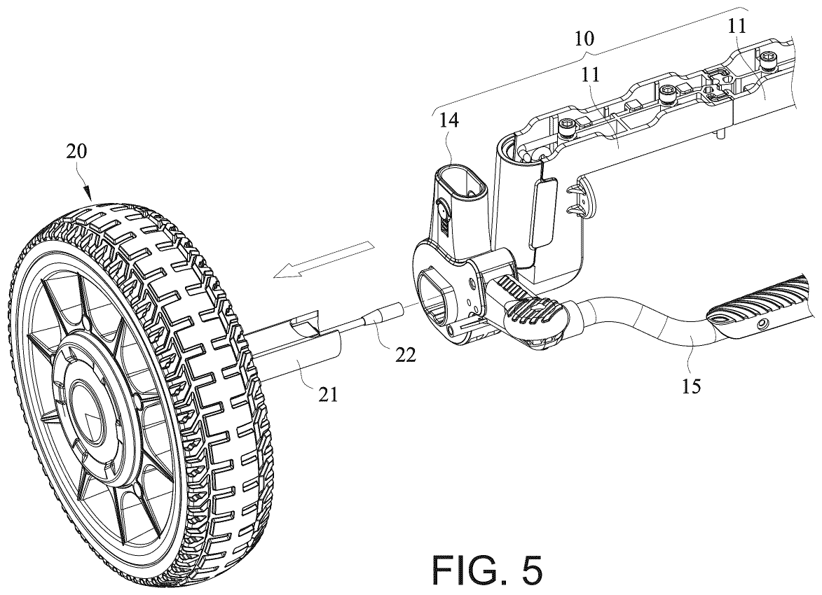

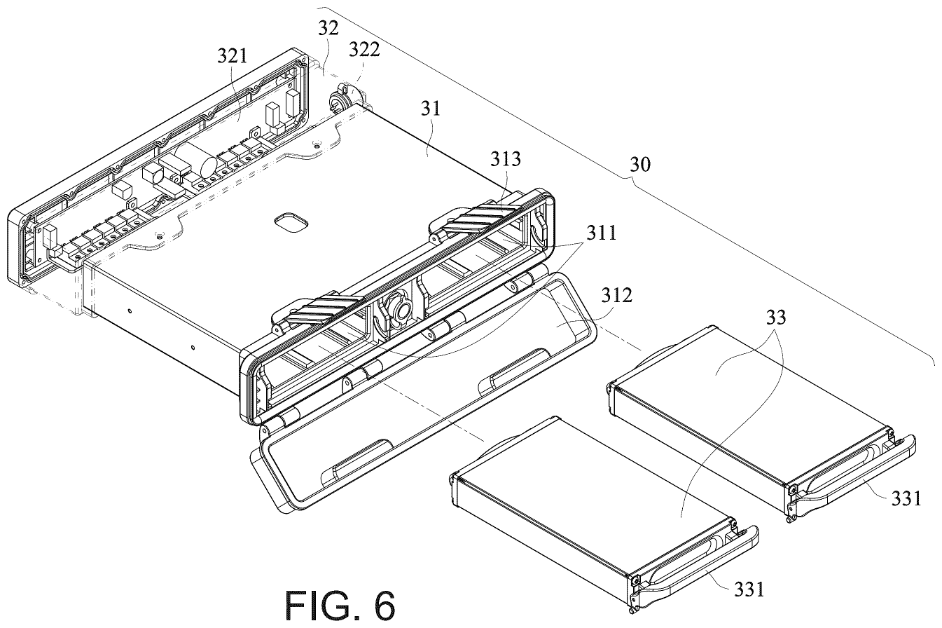

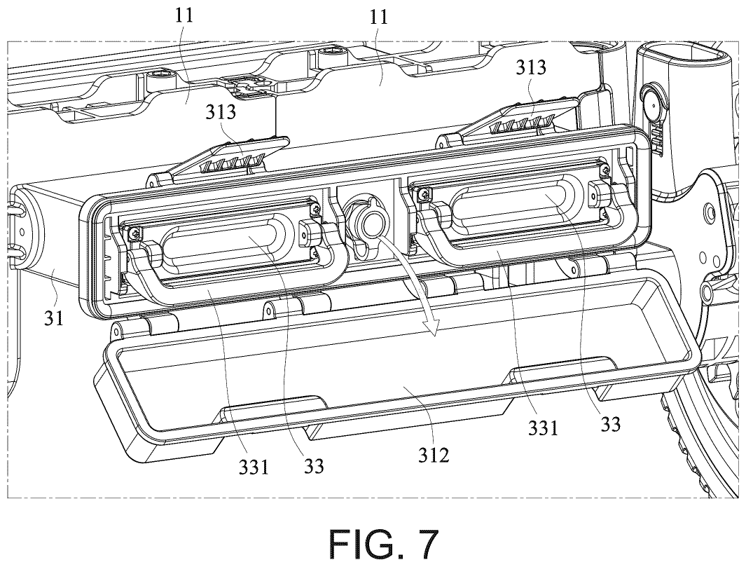

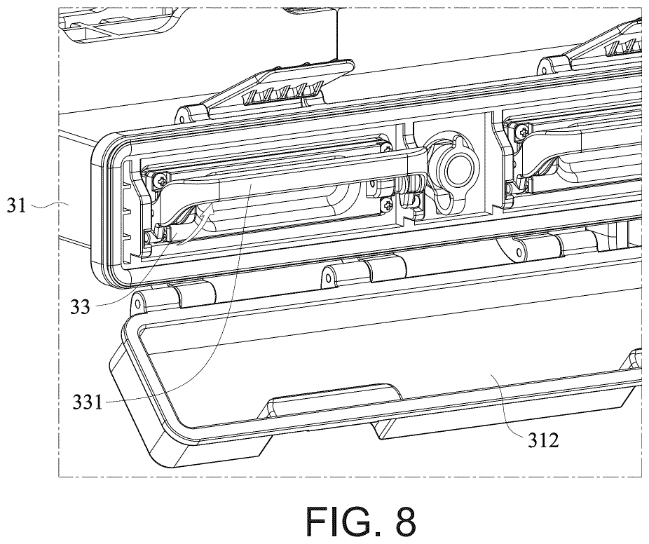

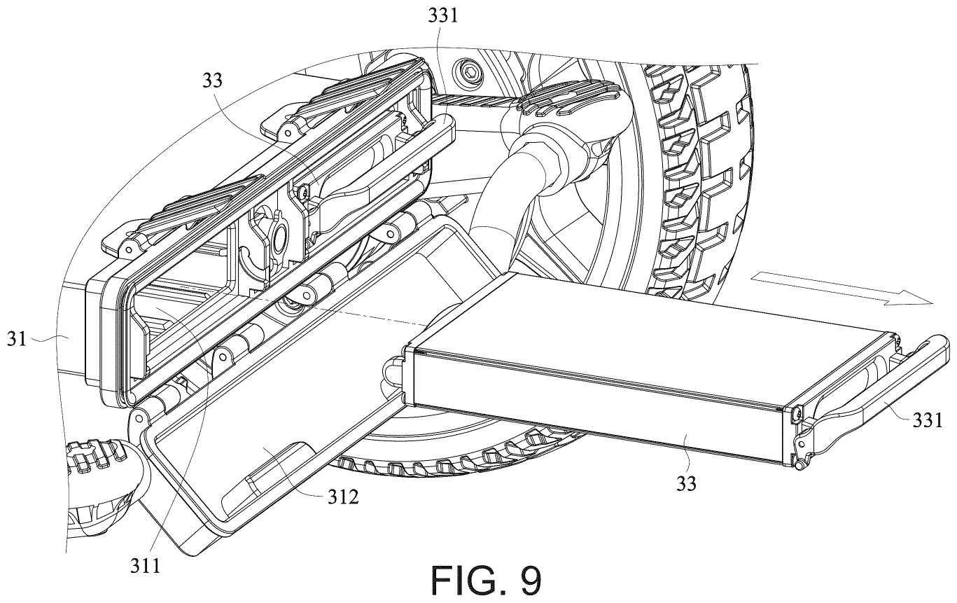

Refer to FIG. 1 through FIG. 9. FIG. 1 is a perspective view of the disclosure. FIG. 2 is a perspective view of the disclosure, showing a support module of the disclosure. FIG. 3 is a perspective view of the disclosure, showing the support module of the disclosure from another angle. FIG. 4 is a schematic view of the disclosure, showing how to use a side lid of the disclosure. FIG. 5 is a schematic view of the disclosure, showing how to use a motor wheel set of the disclosure. FIG. 6 is an exploded view of a battery module of the disclosure. FIG. 7 through FIG. 9 are schematic views of the disclosure, showing how to remove a battery.

As shown in FIG. 1 through FIG. 6, the disclosure provides a detachment structure of a power-assisting battery, applicable to a cart and comprising a support module 10, two motor wheel sets 20, and a battery module 30, as described below in detail.

The support module 10 comprises two supports 11. One end of each support 11 has a raised element 111 and a dented element 112. The supports 11 are fitted together because the raised elements 111 engage with the dented elements 112 respectively. The supports 11 jointly define a receiving space. A removable side lid 12 is disposed on one side of each support 11. Each support 11 receives therein a transmission line 13. One end of the transmission line 13 protrudes from the support 11. The other end of each support 11 is joined to a wheel carrier 14. The wheel carrier 14 is disposed at the cart.

Each motor wheel set 20 has an axle 21. The axle 21 is removably penetratingly disposed at the wheel carrier 14 and the support 11. Each motor wheel set 20 has therein a driving motor. The driving motor extends to form a quick-release transmission connector 22. After passing through the axle 21, the quick-release transmission connector 22 is removably joined to the other end of the transmission line 13.

The battery module 30 is disposed in the receiving space and comprises a battery holder 31, a driver unit 32, and two batteries 33. The battery holder 31 is connected to one end of the transmission line 13 and has two receiving chambers 311. The battery holder 31 is movably, pivotally connected to a waterproof cover 312 for concealing the receiving chambers 311. The battery holder 31 has two fixing components 313. The fixing components 313 engage with the waterproof cover 312. The driver unit 32 comprises a driver 321 and a signal port 322 which are electrically connected to each other. The driver 321 is connected to the battery holder 31. The signal port 322 receives control signals. The batteries 33 are removably disposed in the receiving chambers 311. Each of the batteries 33 has a grip 331 disposed anteriorly.

In an embodiment, the raised elements 111 and the dented elements 112 are hook-shaped.

Thus, the supports 11 are each quickly joined to and detached from related parts and components to reinforce the junctions and prevent separation and detachment under any external force.

In an embodiment, each of the supports 11 has an opening portion corresponding in position to a corresponding one of the side lids 12, and each of the supports 11 has two dents 113 corresponding in position to each of the two sides of the opening portion. The side lids 12 are made of a resilient material. A positioning plate 121 is disposed on each of the two sides of each of the side lids 12. The positioning plate 121 has two bumps 122. The bumps 122 engage with the dents 113 respectively to allow the side lids 12 to be coupled to the supports 11 respectively.

Thus, the side lids 12 can undergo an appropriate degree of resilient deformation without affecting their coupling function. Users operating the side lids 12 can easily allow the bumps 122 to be engaged with or separated from the dents 113. Therefore, the side lids 12 can be easily joined to and detached from related parts and components, and the side lids 12 joined to related parts and components are unlikely to be detached. Furthermore, the motor wheel sets 20 can also be easily joined to and detached from related parts and components, facilitating maintenance and replacement.

In an embodiment, each of the opening portions and each of the side lids 12 of each of the supports 11 correspond in position to the junction of each of the quick-release transmission connectors 22 and a corresponding one of the transmission lines 13.

Thus, upon the removal of the side lids 12, the users can directly, easily remove the quick-release transmission connectors 22.

In an embodiment, the other end of each of the supports 11 is joined to a brake lever 15, and the brake levers 15 are adapted to brake the motor wheel sets 20.

In an embodiment, the axle 21 is penetratingly disposed at the wheel carrier 14 and a corresponding one of the supports 11 and then fastened, with a plurality of screws 23, to the wheel carrier 14 and the corresponding one of the supports 11.

In an embodiment, the grips 331 are movably, pivotally connected to the front surfaces of the batteries 33 respectively.

In an embodiment, a waterproof sealing plastic strip is disposed on the front surface of the battery holder 31 and the rims of the receiving chambers 311.

Thus, hermetical sealing, waterproofing and dustproofing is achieved by shutting the waterproof cover 312 to close the receiving chambers 311 and fastening the batteries 33 in place.

The structural features of the disclosure are described above. The characteristics and advantages of the disclosure are described below.

As shown in FIGS. 3, 4 and 5, the motor wheel sets 20 are detached by following the steps as follows:

First, the screws 23 are removed. Then, the side lids 12 are removed. Next, the quick-release transmission connectors 22 are pulled outward and separated from the transmission lines 13. Finally, the motor wheel sets 20 are pulled outward.

As shown in FIGS. 7, 8 and 9, the batteries 33 are pulled outward by following the steps as follows:

First, the fixing components 313 on the battery holder 31 are opened. Then, the waterproof cover 312 is opened. Next, the grips 331 is pulled upward to easily pull the batteries 33 out of the receiving chambers 311 respectively.

According to the disclosure, the supports 11 are structurally identical and share a mold required for their production to reduce mold making cost and production cost.

According to the disclosure, the driver 321 and the battery holder 31 are integrated into the battery module, and the batteries 33 are replaceable.

According to the disclosure, owing to the waterproof cover 312, the battery holder 31 is waterproof and dustproof.

According to the disclosure, a user can pull the batteries 33 outward easily by the grips 331 of the batteries 33, and the fixing component 313 allows the waterproof cover 312 to be shut and locked as well as unlocked and opened.

According to the disclosure, the battery holder 31 can charge multiple batteries 33 simultaneously.

What is claimed is:

1. A detachment structure of a power-assisting battery, applicable to a cart, comprising:
a support module comprising two supports each having an end, the end having a raised element and a dented element, the supports being fitted together because of the raised elements engaging with the dented elements respectively, the supports jointly defining a receiving space, with a removable side lid disposed on a side of each of the supports and a transmission line received in each of the supports, the transmission line having an end protruding from the support, wherein another end of each of the supports is joined to a wheel carrier disposed at the cart;
two motor wheel sets, each having therein a driving motor and each having an axle, the axle being removably penetratingly disposed at the wheel carrier and a corresponding one of the supports, the driving motor extending to form a quick-release transmission connector, wherein, after passing through the axle, the quick-release transmission connector is removably joined to another end of the transmission line; and
a battery module disposed in the receiving space and comprising a battery holder, a driver unit, and at least one battery, the battery holder being connected to an end of the transmission line, having at least one receiving chamber, being movably, pivotally connected to a waterproof cover to conceal the receiving chamber, and having at least one fixing component for engaging with the waterproof cover, the driver unit comprising a driver and a signal port electrically connected to each other, the driver connecting to the battery holder, and the signal port receiving control signals, with the battery removably disposed in the receiving chamber and having a grip disposed anteriorly.

2. The detachment structure of a power-assisting battery according to claim 1, wherein the raised elements and the dented elements are hook-shaped.

3. The detachment structure of a power-assisting battery according to claim 1, wherein each of the supports has an opening portion corresponding in position to a corresponding one of the side lids, and each of the supports has two dents corresponding in position to each of the two sides of the opening portion, with the side lids made of a resilient material, with a positioning plate disposed on each of the two sides of each of the side lids and having two bumps, the bumps engaging with the dents respectively to allow the side lids to be coupled to the supports respectively.

4. The detachment structure of a power-assisting battery according to claim 1, wherein each of the opening portions and each of the side lids of each of the supports correspond in position to a junction of each of the quick-release transmission connectors and a corresponding one of the transmission lines.

5. The detachment structure of a power-assisting battery according to claim 1, wherein another end of each of the supports is joined to a brake lever, and the brake levers are adapted to brake the motor wheel sets.

6. The detachment structure of a power-assisting battery according to claim 1, wherein the axle is penetratingly disposed at the wheel carrier and a corresponding one of the supports and then fastened, with a plurality of screws, to the wheel carrier and the corresponding one of the supports.

7. The detachment structure of a power-assisting battery according to claim 1, wherein the grips are movably, pivotally connected to front surfaces of the batteries respectively.

8. The detachment structure of a power-assisting battery according to claim 1, wherein a waterproof sealing plastic strip is disposed on a front surface of the battery holder and rims of the receiving chambers.
